(19) United States
(12) Patent Application Publication
(10) Pub. No.: US 2026/0104146 A1
(43) Pub. Date: Apr. 16, 2026

(54) IOT SYSTEMS, METHODS, AND STORAGE MEDIA FOR SMART REGULATION AND CONTROL OF GAS FLOWS

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Yaqiang QUAN, Chengdu (CN); Guanghua HUANG, Chengdu (CN)

(73) Assignee: CHENGDU QINCHUAN IOT TECHNOLOGY CO., LTD., Chengdu (CN)

(21) Appl. No.: 19/357,141

(22) Filed: Oct. 14, 2025

(30) Foreign Application Priority Data
Sep. 3, 2025 (CN) 202511249784.6

(51) Int. Cl. F17D 5/00; F17D 3/01; G05B 13/02

(52) U.S. Cl. CPC F17D 5/005; F17D 3/01; G05B 13/0265

(57) ABSTRACT

An IoT system, a method, and a storage medium for smart regulation and control of a gas flow are provided. The method includes: determining whether a gas feature of a matching gas source corresponding to a gas pipeline to be regulated exists in a gas data center; in response to determining that the gas feature exists in the gas data center, retrieving the gas feature from the gas data center, and generating a timeliness attribute of the gas feature; generating a first flow regulation parameter based on the gas feature and the timeliness attribute; and sending a flow regulation instruction to a flow regulation device on the gas pipeline to be regulated, to adjust a gas flow rate and a gas pressure allocated to the gas pipeline to be regulated. A gas in the gas pipeline to be regulated is mixed in a gas pipeline to generate a mixed gas.

### CROSS-REFERENCE TO RELATED APPLICATIONS

This application claims priority to Chinese Patent Application No. 202511249784.6, filed on Sep. 3, 2025, the entire content of which is hereby incorporated by reference.

### TECHNICAL FIELD

The present disclosure relates to the field of monitoring and control of pipelines, and in particular relates to an Internet of Things (IoT) system, a method, and a storage medium for smart regulation and control of a gas flow.

### BACKGROUND

Natural gas supply systems generally utilize a variety of gas sources (e.g., natural gas, hydrogen-doped gas, liquefied petroleum gas (LPG), and coal gas) to satisfy the demands of different users. However, in practical applications, due to the diversity of the gas sources, combustion characteristics (e.g., a calorific value, a temperature, a combustion rate, etc.) of a mixed gas may change or become unstable, thus affecting the normal use of gas users. It is difficult to achieve precise control and timely adjustment of a gas flow rate through manual experience and regular testing.

Therefore, it is desirable to provide an IoT system, a method, and a storage medium for smart regulation and control of a gas flow, which can achieve automatic and intelligent mixing and delivery of gas, facilitate timely regulation of the gas flow, ensure effective regulation, and improve user experience.

### SUMMARY

One or more embodiments of the present disclosure provide an Internet of Things (IoT) system for smart regulation and control of a gas flow. The IoT system includes a governmental gas supervision management platform, a governmental gas supervision sensing network platform, a governmental gas supervision object platform, a gas company sensing network platform, and a gas device object platform, which are communicatively connected. The governmental gas supervision object platform includes a gas company management platform communicatively connected to a gas user platform through a gas user service platform. The gas company management platform is configured on a server of a gas company, and the server is provided with a gas data center. The gas device object platform is communicatively connected to a flow regulation device. The gas company management platform is configured to: determine whether a gas feature of a matching gas source corresponding to a gas pipeline to be regulated exists in the gas data center; in response to determining that the gas feature exists in the gas data center, retrieve the gas feature from the gas data center, and generate a timeliness attribute of the gas feature; generate a first flow regulation parameter based on the gas feature and the timeliness attribute; and based on the first flow regulation parameter, send a flow regulation instruction to the flow regulation device provided on the gas pipeline to be regulated via the gas company sensing network platform and through the gas device object platform, to adjust a gas flow rate and a gas pressure allocated to the gas pipeline to be regulated, wherein a gas in the gas pipeline to be regulated is mixed in a gas pipeline to generate a mixed gas.

One or more embodiments of the present disclosure provide a method for smart regulation and control of a gas flow. The method is executed by a gas company management platform of an Internet of Things (IoT) system for smart regulation and control of a gas flow. The gas company management platform is configured on a server of a gas company. The server is provided with a gas data center. The method includes: determining whether a gas feature of a matching gas source corresponding to a gas pipeline to be regulated exists in the gas data center; in response to determining that the gas feature exists in the gas data center, retrieving the gas feature from the gas data center, and generating a timeliness attribute of the gas feature; generating a first flow regulation parameter based on the gas feature and the timeliness attribute; and based on the first flow regulation parameter, sending a flow regulation instruction to the flow regulation device provided on the gas pipeline to be regulated via a gas company sensing network platform and through a gas device object platform, to adjust a gas flow rate and a gas pressure allocated to the gas pipeline to be regulated, wherein a gas in the gas pipeline to be regulated is mixed in a gas pipeline to generate a mixed gas.

One or more embodiments of the present disclosure provide a non-transitory computer-readable storage medium storing computer instructions. When reading the computer instructions in the storage medium, a computer implements the method for smart regulation and control of a gas flow described in one or more embodiments of the present disclosure.

### BRIEF DESCRIPTION OF THE DRAWINGS

The present disclosure will be further illustrated by way of exemplary embodiments, which will be described in detail with reference to the drawings. These embodiments are not limiting, and in these embodiments, the same numeral denotes the same structure, wherein:

FIG. 1 is a block diagram of a platform structure of an Internet of Things (IoT) system for smart regulation and control of a gas flow according to some embodiments of the present disclosure.

FIG. 2 is a flowchart of an exemplary process for smart regulation and control of a gas flow according to some embodiments of the present disclosure.

FIG. 3 is a schematic diagram of an exemplary flow regulation model according to some embodiments of the present disclosure.

FIG. 4 is a flowchart of an exemplary process for determining an updated gas feature according to some embodiments of the present disclosure.

FIG. 5 is a schematic diagram of an exemplary flow regulation device according to some embodiments of the present disclosure.

### DETAILED DESCRIPTION

To more clearly illustrate the technical solutions of the embodiments of the present disclosure, the drawings required to be used in the description of the embodiments will be briefly described below. Obviously, the drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that, as used herein, the terms “system”, “device”, “unit”, and/or “module” as used herein is a way to distinguish between different components, elements, parts, sections, or assemblies at different levels. However, these words may be replaced by other expressions if other words accomplish the same purpose.

The term “and/or”, as used herein, is merely a way of describing the associative relationship of an associated object, indicating that three relationships can exist, e.g., A and/or B, which may be represented as: An alone, both A and B, and B alone.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Flowcharts are used in the present disclosure to illustrate operations performed by a system according to embodiments of the present disclosure. It should be appreciated that the preceding or following steps are not necessarily performed in an exact sequence. Instead, steps may be processed in reverse order or simultaneously. Also, it is possible to add other steps to these processes or remove a step or steps from these processes.

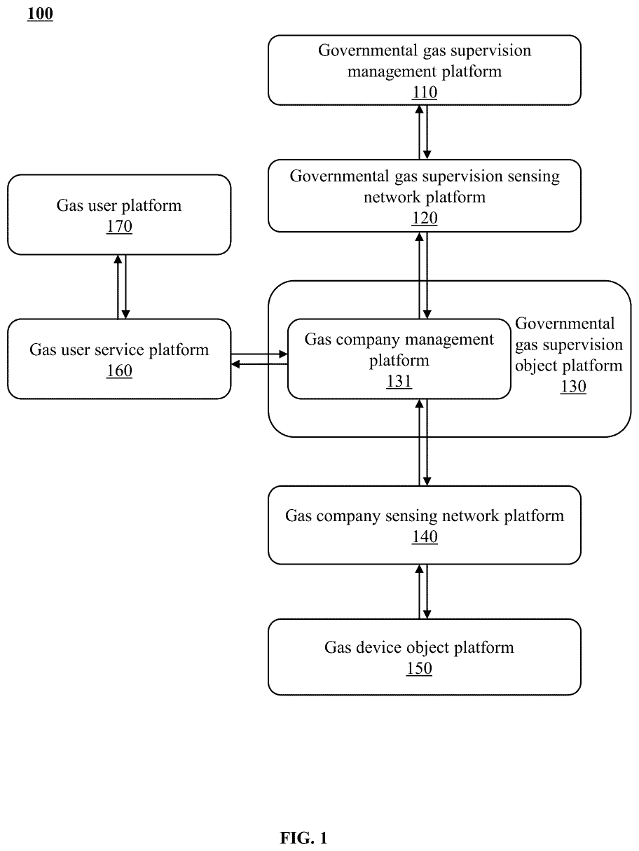

FIG. 1 is a block diagram of a platform structure of an Internet of Things (IoT) system for smart regulation and control of a gas flow according to some embodiments of the present disclosure.

In some embodiments, as shown in FIG. 1, an IoT system 100 for smart regulation and control of a gas flow (hereinafter referred to as the system 100) includes a governmental gas supervision management platform 110, a governmental gas supervision sensing network platform 120, a governmental gas supervision object platform 130, a gas company sensing network platform 140, a gas device object platform 150, a gas user service platform 160, and a gas user platform 170 which are communicatively connected.

The governmental gas supervision management platform refers to a platform for the government to regulate and manage gas. In some embodiments, the governmental gas supervision management platform may be configured as a processor (e.g., one or a combination of a microcontroller, an embedded processor, and a graphics processor).

The governmental gas supervision sensing network platform refers to a platform for sensing communication of regulatory-related information and sensing communication of control information. For example, the governmental gas supervision sensing network platform may be configured as a communication device and a server.

In some embodiments, the governmental gas supervision sensing network platform may interact with the governmental gas supervision management platform and the governmental gas supervision object platform for data exchange. The governmental gas supervision object platform refers to a platform configured to provide data related to gas usage, operation, safety, and to execute control information.

In some embodiments, the governmental gas supervision object platform may include a gas company management platform 131. The gas company management platform refers to a platform that manages gas-related data of a gas company.

In some embodiments, the gas company management platform is communicatively connected to the gas company sensing network platform.

In some embodiments, the gas company management platform is configured on a server of the gas company, with a gas data center located on the server.

The server refers to a device that provides computing or application services to other devices. In some embodiments, the server may be configured as a single server, a group of servers, etc. The group of servers may be centralized or distributed (e.g., the servers may be a distributed system). The server(s) may be local or remote.

The gas data center refers to a database used by the gas company to collect and process gas-related data. In some embodiments, the gas data center may be located in a server hosting the gas company management platform.

The gas company sensing network platform refers to a platform for perceptual information sensing communication and control information sensing communication. For example, the gas company sensing network platform may be configured as a communication device, a server, or the like.

In some embodiments, the gas company sensing network platform may interact with the gas company management platform and the gas device object platform for data exchange.

The gas device object platform refers to a functional platform for the generation of sensing information and the execution of control information for a gas device. For example, the gas device object platform may be configured as a user terminal or a user server. For example, the user terminal may include a cell phone, a tablet, a client, a web page, or the like. In some embodiments, the gas device object platform may be configured in a gas-using end-user household, a gas gate station, a gas field station, a gas regulator station, a valve well, a refueling station, an appurtenant facility, etc., of a gas pipeline network.

In some embodiments, the gas device object platform is communicatively connected to a flow regulation device and/or a pipeline monitoring device.

The flow regulation device refers to a device used in a gas pipeline to regulate a flow rate, a pressure, etc., of gas. In some embodiments, one gas pipeline requiring flow regulation may correspond to one flow regulation device.

The pipeline monitoring device refers to a device for monitoring pipeline-related data. In some embodiments, the pipeline monitoring device may include, but is not limited to, one or more of a pressure monitor, a transducer, a gas composition analyzer, a flow detector, a surveillance camera, a calorimetric analyzer, a combustion efficiency meter, and an ultrasonic monitoring device.

The gas user service platform refers to a platform for information interaction between the gas company and gas users.

In some embodiments, the gas user service platform may be configured in a server of the gas company.

The gas user platform refers to a platform that interacts with the gas users. In some embodiments, the gas user platform may be configured in a terminal of the gas user.

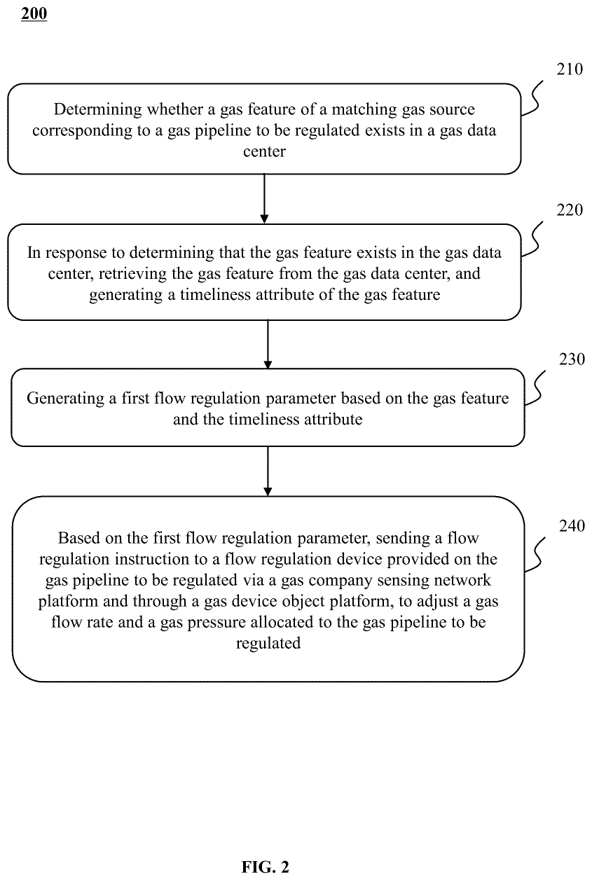

More descriptions regarding the platforms may be found in FIG. 2-FIG. 5 and related descriptions thereof.

Based on system 100, communication connections can be established among the various functional platforms, forming a closed-loop information flow between the platforms. Under the unified management of the gas company management platform, these platforms operate in a coordinated and regular manner, thereby achieving information-based and smart gas flow regulation and control.

FIG. 2 is a flowchart of an exemplary process for smart regulation and control of a gas flow according to some embodiments of the present disclosure. In some embodiments, process 200 is performed by a gas company management platform.

In 210, determining whether a gas feature of a matching gas source corresponding to a gas pipeline to be regulated exists in a gas data center.

The gas pipeline to be regulated refers to a gas pipeline in which parameters such as gas flow rate and gas pressure may be adjusted.

In some embodiments, one matching gas source corresponds to one gas pipeline to be regulated.

The matching gas source refers to a gas source corresponding to a gas pipeline to be regulated that matches a mixed gas. For example, for a mixed gas A, which corresponds to two gas pipelines to be regulated, gases from these two pipelines may be regulated and then converge into a gas pipeline to form the mixed gas. The gas sources corresponding to the two pipelines to be regulated are the matching gas sources. The gas pipeline refers to a pipeline that transports gas to a gas user.

The gas feature refers to a feature of gas in the gas pipeline to be regulated. For example, the gas feature includes at least one of a gas type, a calorific value, a combustion rate, a gas pressure, or a combustion quality.

In some embodiments, the gas in the gas pipeline to be regulated may be a single type of gas, a mixed gas, etc. When the gas in the gas pipeline to be regulated is a mixed gas, the gas feature may further include a ratio of different types of gases forming the mixed gas, etc.

In some embodiments, one matching gas source corresponds to one set of gas features for one gas pipeline to be regulated.

More descriptions regarding the mixed gas may be found in the related descriptions of step 240 in FIG. 2.

In some embodiments, the gas feature may further include a valid gas feature. The valid gas feature refers to a gas feature whose timeliness attribute is valid. More descriptions regarding the timeliness attribute may be found in the related descriptions of operation 220 in FIG. 2.

In some embodiments, a pipeline monitoring device acquires the gas feature of the matching gas source corresponding to the gas pipeline to be regulated and stores the gas feature in the gas data center.

In some embodiments, the gas company management platform may retrieve and determine whether the gas feature of the matching gas source corresponding to the gas pipeline to be regulated exists in the gas data center. The gas data center may store gas features and historical gas features separately. The gas features refer to gas features stored relatively close to a current time (e.g., within 30 days). The historical gas features refer to gas features stored relatively far from the current time the current time (e.g., more than 1 month). When the gas data center contains only historical gas features of the matching gas source corresponding to the gas pipeline to be regulated, the gas company management platform determines that gas feature of the matching gas source corresponding to the gas pipeline to be regulated the gas data center does not exist in the gas data center. When the gas data center contains one or more gas features of the matching gas source corresponding to the gas pipeline to be regulated, the gas company management platform determines that the gas feature of the matching gas source corresponding to the gas pipeline to be regulated exists in the gas data center.

In 220, in response to determining that the gas feature of the matching gas source corresponding to the gas pipeline to be regulated exists in the gas data center, retrieving the gas feature from the gas data center, and generating a timeliness attribute of the gas feature.

The timeliness attribute refers to a property that characterizes whether or not the gas feature is valid in a current flow regulation process. For example, the timeliness attribute may be represented as valid or invalid.

In some embodiments, the gas company management platform may generate the timeliness attribute of the gas feature based on, for example, warning information from the pipeline monitoring device. The warning information from the pipeline monitoring device refers to information indicating that the pipeline monitoring device monitors a change in the gas feature, or that the pipeline monitoring device generates a malfunction, etc.

For example, if the gas company management platform receives fault information from the pipeline monitoring device or information indicating a drastic change in the gas feature (e.g., the matching gas source has been replaced or adjusted, etc., which may cause a drastic change), the timeliness attribute of the gas feature is determined to be invalid; otherwise, the timeliness attribute of the gas feature is determined to be valid.

In some embodiments, the gas company management platform may also generate the timeliness attribute of the gas feature based on a storage time of the gas feature.

For example, the gas company management platform may determine a time interval between the storage time of the gas feature and the current time. If the time interval is greater than a preset duration, the gas company management platform may determine that the timeliness attribute of the gas feature is invalid. The preset duration refers to a predetermined time interval for judging the timeliness attribute as invalid. For example, the preset duration may be 15 days.

In 230, generating a first flow regulation parameter based on the gas feature and the timeliness attribute.

The first flow regulation parameter refers to one or more parameters used to regulate different flow regulation devices on different gas pipelines to be regulated. In some embodiments, the first flow regulation parameter may include gas flow rates and gas pressures corresponding to different flow regulation devices on different gas pipelines to be regulated.

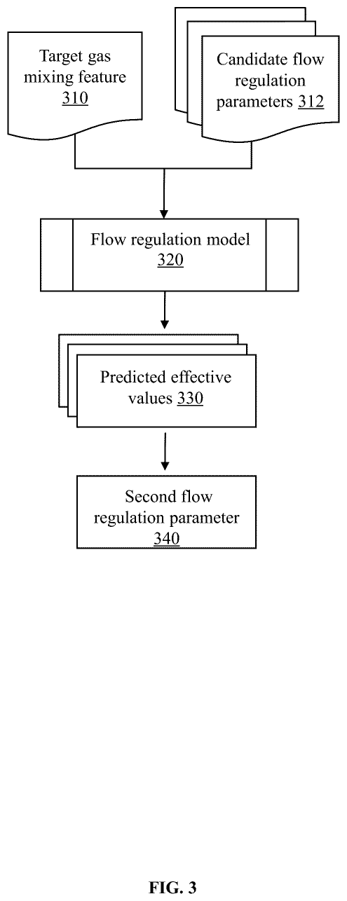

In some embodiments, the gas company management platform may generate the first flow regulation parameter in a variety of ways. For example, when the gas company management platform determines that the timeliness attributes corresponding to acquired gas features of gas pipelines to be regulated are all valid, the gas company management platform may determine the first flow regulation parameter through a first predetermined table based on the gas feature. The first predetermined table may include gas features, flow regulation parameters, and a correspondence relationship between the gas features and the flow regulation parameters. The gas company management platform may organize historical flow regulation data by compiling historical flow regulation parameters that are used to achieve successful flow regulation and historical gas features corresponding to the flow regulation parameters that are used to achieve successful flow regulation into the first predetermined table. The gas company management platform may construct a vector for the gas feature (also referred to as a gas feature vector) and vectors for the historical gas features corresponding to the historical flow regulation parameters that achieve successful flow regulation (also referred to as historical gas feature vectors), and determine a similarity between the gas feature vector and each of the historical gas feature vectors. The historical flow regulation parameter corresponding to the historical gas feature with the largest similarity is designated as the first flow regulation parameter. The successful flow regulation refers to that a gas mixing feature of the mixed gas in the gas pipeline after the flow regulation reaches a target gas mixing feature. The similarity may include cosine similarity, Euclidean distance, etc. More descriptions regarding the gas mixing feature and the target gas mixing feature may be found in FIG. 3.

In some embodiments, when the gas feature does not exist in the gas data center or there are one or more gas features whose timeliness attribute is invalid, the gas company management platform generates a second flow regulation parameter based on a historical gas mixing feature and the historical flow regulation parameter. More details may be found in the relevant descriptions of FIG. 2.

In 240, based on the first flow regulation parameter, sending a flow regulation instruction to the flow regulation device provided on the gas pipeline to be regulated via a gas company sensing network platform (e.g., the gas company sensing network platform 140) and through a gas device object platform (e.g., the gas device object platform 150), to adjust a gas flow rate and a gas pressure allocated to the gas pipeline to be regulated. The gas in the gas pipeline to be regulated is mixed in the gas pipeline to generate the mixed gas.

The flow regulation instruction refers to an instruction issued to control the flow regulation device to perform flow regulation on the gas pipeline to be regulated. In some embodiments, the flow regulation instruction includes related signals corresponding to data such as gas flow rates and gas pressures corresponding to different gas pipelines to be regulated.

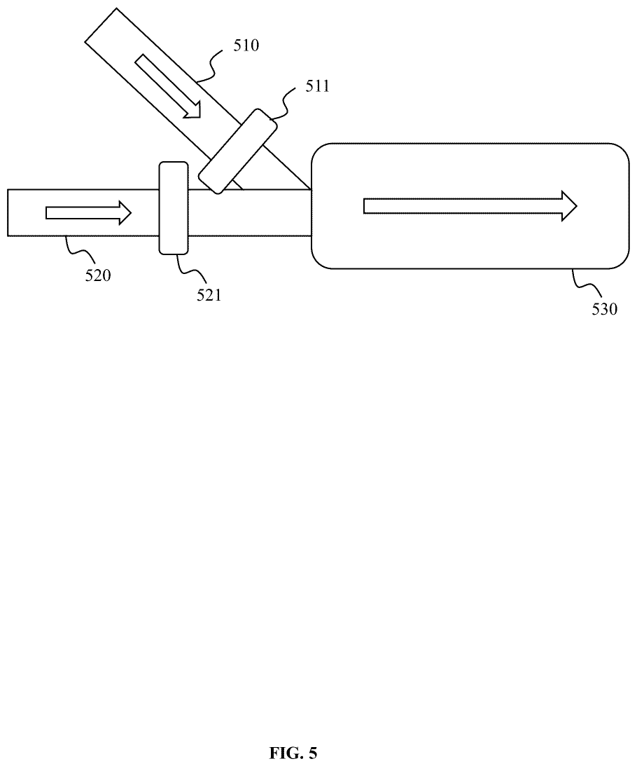

FIG. 5 is a schematic diagram of an exemplary flow regulation device according to some embodiments of the present disclosure. Taking two gas pipelines to be regulated as an example, as shown in FIG. 5, each of a first gas pipeline to be regulated 510 and a second gas pipeline to be regulated 520 may be provided with a flow regulation device. The gas company management platform adjusts a gas flow rate and a gas pressure of the first gas pipeline to be regulated 510 through a first flow regulation device 511, and adjusts a gas flow rate and a gas pressure of the second gas pipeline to be regulated 520 through a second flow regulation device 521, so that the gas flow rates and the gas pressures of the first gas pipeline to be regulated 510 and the second gas pipeline to be regulated 520 reach required values, respectively.

In some embodiments, gases in a plurality of gas pipelines to be regulated are mixed in a gas pipeline to generate a mixed gas. The mixed gas refers to a gas obtained by mixing a plurality of types of gases. For example, the mixed gas may be a hydrogen-doped gas.

In some embodiments, the gas company management platform may generate the mixed gas by mixing the gases in the gas pipelines to be regulated through the gas pipelines to be regulated. As shown in FIG. 5, a gas from the first gas pipeline to be regulated 510 and a gas from the second gas pipeline to be regulated 520 are transported to a gas pipeline 530 and mixed to generate a mixed gas.

In some embodiments, in response to determining that the gas feature does not exist in the gas data center and/or the timeliness attribute of the gas feature includes invalidity, the gas company management platform generates a second flow regulation parameter for a future time point based on a historical gas mixing feature of the mixed gas and a historical flow regulation parameter; based on the second flow regulation parameter, sends the flow regulation instruction to the flow regulation device via the gas company sensing network platform and through the gas device object platform, to pre-adjust the gas flow rate and the gas pressure allocated to the gas pipeline to be regulated; and sends the second flow regulation parameter to a governmental gas supervision management platform (e.g., the governmental gas supervision management platform 110) via a governmental gas supervision sensing network platform (e.g., the governmental gas supervision sensing network platform 120).

It should be noted that since there may be more than one matching gas source, there may be more than one timeliness attribute corresponding to a gas feature of the matching gas source. The timeliness attribute may include validity and/or invalidity, and the timeliness attribute including invalidity refers to that the timeliness attribute of the gas feature of at least one matching gas source is invalid.

The historical gas mixing feature refers to one or more gas features of a mixed gas monitored at a historical time point. In some embodiments, the historical gas mixing feature may include at least one of a flow rate, a pressure, a temperature, etc., of the mixed gas.

In some embodiments, the gas company management platform may obtain the historical gas mixing feature that is pre-stored in the gas data center.

The historical flow regulation parameter refers to one or more flow regulation parameters corresponding to different flow regulation devices on different gas pipelines to be regulated, wherein the historical flow regulation parameter is associated with the historical gas mixing feature. In other words, historical flow regulation parameters were applied to different flow regulation devices on different gas pipelines to be regulated in order to achieve (or that were associated with) corresponding historical gas mixing features. For example, the historical flow regulation parameter includes flow regulation parameters that have been applied to different flow regulation devices at historical time points. In some embodiments, one historical gas mixing feature corresponds to historical flow regulation parameters of different flow regulation devices at one historical time point.

In some embodiments, the gas company management platform may determine the historical flow regulation parameter in a variety of ways. For example, the platform may directly retrieve from historical data, for a plurality of historical time points, a set of data for each time point, wherein each set of data corresponds to the same gas pipeline and the same gas pipeline to be regulated as the current scenario and comprises: (1) a historical gas mixing feature, and (2) a historical flow regulation parameter corresponding to the historical gas mixing feature.

The second flow regulation parameter refers to one or more flow regulation parameters corresponding to different flow regulation devices on different gas pipelines to be regulated at a future time point.

In some embodiments, the gas company management platform may generate the second flow regulation parameter in various ways. For example, the gas company management platform may construct vectors for historical gas mixing features obtained at a plurality of historical time points and a vector of the target gas mixing feature based on the historical gas mixing feature of the gas pipeline and the target gas mixing feature. A similarity between the vector of the target gas mixing feature and each of the vectors of the historical gas mixing features is determined, and the historical flow regulation parameter corresponding to the historical gas mixing feature with the largest similarity is determined as the second flow regulation parameter. The target gas mixing feature refers to a preset gas mixing feature that meets requirements.

In some embodiments, the gas company management platform may generate the second flow regulation parameter based on the historical gas mixing feature, the historical flow regulation parameter, and the valid gas feature.

In some embodiments, the gas company management platform may filter out a plurality of historical gas mixing features whose similarity is greater than a similarity threshold, along with a plurality of historical flow regulation parameters corresponding to the plurality of historical gas mixing features. The gas company management platform then retrieves the historical gas features of the plurality of gas pipelines to be regulated that correspond to the plurality of historical flow regulation parameters. Subsequently, for gas pipelines to be regulated that share the same gas type as those with the valid gas feature, the gas company management platform determines a similarity between each of the historical gas features and the valid gas feature. Finally, the historical flow regulation parameter corresponding to the historical gas feature with the highest similarity is selected as the second flow regulation parameter.

Based on the historical gas mixing feature, the historical flow regulation parameter, and the valid gas feature, the second flow regulation parameter is generated, which is helpful for determining the second flow regulation parameter that satisfies the demands of gas users in a more reasonable manner.

In some embodiments, the gas company management platform determines, through the gas data center, a third flow regulation parameter satisfying a predetermined condition based on a gas source type and gas source physical state of an invalid matching gas source and the valid gas feature, and generates the second flow regulation parameter based on the third flow regulation parameter.

The gas source type includes one of natural gas, liquefied petroleum gas (LPG), coal gas, hydrogen-doped gas, etc. The gas source physical state refers to a physical state of the gas source. The gas source physical state includes a gaseous state and a liquid state.

In some embodiments, the gas company management platform may obtain the gas source type and the gas source physical state of the invalid matching gas source through the gas data center.

In some embodiments, the gas company management platform may determine the third flow regulation parameter in various ways. For example, the gas company management platform may obtain the gas source type and the gas source physical state of the invalid matching gas source. Based on the gas source type and the gas source physical state of the invalid matching gas source and the valid gas feature, the gas company management platform screens the gas data center for a plurality of historical flow adjustment data and their corresponding historical flow regulation parameters that match the gas source type and the gas source physical state of the invalid matching gas source, and whose similarity to the valid gas feature exceeds a similarity threshold. Based on the predetermined condition, the gas company management platform selects from the plurality of historical flow regulation parameters a historical flow regulation parameter that satisfies the predetermined condition as the third flow regulation parameter. The similarity threshold may be predetermined by the gas company management platform by default.

The predetermined condition refers to a condition that is set in advance for selecting the third flow regulation parameter. The third flow regulation parameter refers to a device parameter of the flow regulation device that is selected from the gas data center.

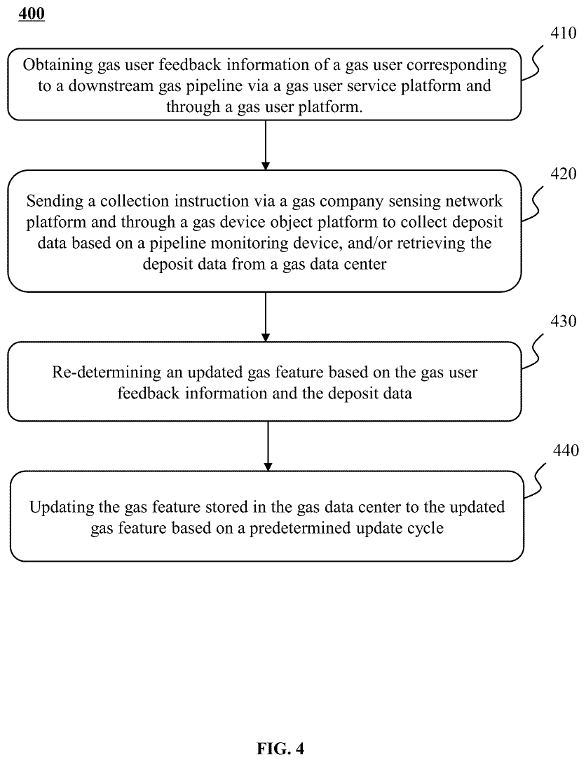

In some embodiments, the predetermined condition includes an actual effective value of the third flow regulation parameter being greater than a predetermined threshold. The actual effective value is determined based on gas user feedback information of the gas user. More descriptions regarding the gas user feedback information may be found in FIG. 4 and related descriptions thereof.

The actual effective value refers to a value that reflects a degree to which the third flow regulation parameter meets the demands of a gas user. The actual effective value may be expressed as a numerical value. For example, the actual effective value may be a value between 0 and 1. The closer the value is to 1, the better the third flow regulation parameter meets the demands of the gas users.

In some embodiments, one historical flow regulation parameter corresponds to one actual effective value.

In some embodiments, the gas company management platform may determine different actual effective values corresponding to different historical flow regulation parameters based on the gas user feedback information of the gas user.

In some embodiments, the actual effective values are inversely proportional to an amount of gas user feedback information, and positively proportional to a feedback time interval. For example, the actual effective value may be determined by Equation (1):

$$Y = 1 - {\sum }_{i = 1}^{N} \frac{{a}_{i} \times {b}_{i} \times {e}^{1 - {c}_{i}}}{d} . \qquad ( 1 )$$

In Equation (1), Y denotes the actual effective value, N denotes a count of time intervals between a user feedback time and a flow adjustment start time, i denotes an index number identifying a specific time interval, at denotes a severity coefficient corresponding to an ith time interval, bᵢ denotes the amount of gas user feedback information corresponding to the ith time interval, e denotes a base of a natural logarithm (exponential function), cᵢ denotes the feedback time interval corresponding to the ith time interval, and d denotes a count of the gas user. The feedback time interval may be an average value. For example, the feedback time interval may be 1 minute, 10 minutes, etc. The larger the feedback time interval, the more data is processed by the gas company management platform. The severity coefficient refers to a coefficient related to a degree of impact of the gas user feedback information. The severity coefficient may be expressed as a value (e.g., 0.2, 0.5, or 1), and the closer the value is to 1, the higher the degree of impact of the gas user feedback information. The severity coefficient may be determined by a technician based on experience.

The count of time intervals between the user feedback time and the flow adjustment start time may include a statistically counted count of time intervals between the user feedback time and the flow adjustment start time. For example, gas user feedback information received within 1 minute after 2 hours of flow regulation is designated as gas user feedback information for a first time interval, and gas user feedback information received within 1 minute after 6 hours of flow regulation is designated as gas user feedback information for a second time interval. In this scenario, the count of time intervals is N=2.

The predetermined threshold refers to a predefined threshold value for the actual effective value.

The predetermined condition is that the actual effective value of the third flow regulation parameter is greater than the predetermined threshold, and the actual effective value is determined by the gas user feedback information of the gas user, which is conducive to full consideration of actual gas consumption demand of the user, and thus makes the adjustment of the second flow regulation parameter more in line with actual conditions.

In some embodiments, the gas company management platform may determine the second flow regulation parameter based on the third flow regulation parameter. For example, the gas company management platform may determine the third flow regulation parameter that has the largest actual effective value as the second flow regulation parameter.

By leveraging the gas source type and the gas source physical state of the invalid matching gas source, along with the valid gas feature, and by using the gas data center to identify the third flow regulation parameter that meets the predetermined condition, the process facilitates the generation of the second flow regulation parameter. This approach helps determine a more reasonable and practical flow adjustment effectiveness value. Based on the magnitude of the effectiveness value, the appropriateness of the third flow regulation parameter can be assessed, ultimately allowing for the identification of the second flow regulation parameter that best meets the needs of the majority of gas users.

In some embodiments, the gas company management platform may determine, through a flow regulation model, predicted effective value(s) based on the target gas mixing feature and at least one candidate flow regulation parameter, and determine the second flow regulation parameter based on the predicted effective value(s). More descriptions may be found in FIG. 3 and related descriptions thereof.

In response to determining that the gas feature does not exist in the gas data center and/or the timeliness attribute includes invalidity, the second flow regulation parameter is generated based on the historical gas mixing feature and the historical flow regulation parameter. This facilitates the determination of flow regulation parameters suitable for different scenarios, thereby providing a reasonable reference for the current flow adjustment and further enhancing the user experience.

In response to determining that the gas feature exists in the gas data center, the timeliness attribute of the gas feature is assessed. Then, the first flow regulation parameter is generated to adjust the gas flow rate and the gas pressure. This approach enables timely flow adjustments, fully ensures the effectiveness of the gas flow regulation, reduces issues such as adjustment lag or delays, and improves the user experience.

FIG. 3 is a schematic diagram of an exemplary flow regulation model according to some embodiments of the present disclosure.

In some embodiments, as shown in FIG. 3, a gas company management platform (e.g., the gas company management platform 131) determines, based on a target gas mixing feature 310 and a plurality of candidate flow regulation parameters 312, predicted effective values 330 of the plurality of candidate flow regulation parameters through a flow regulation model 320, and determines a second flow regulation parameter 340 based on the predicted effective values 330.

The flow regulation model refers to a model for determining predicted effective values of a plurality of candidate flow regulation parameters. In some embodiments, the flow regulation model may be a machine learning model. For example, the flow regulation model may be one of a Neural Networks (NN) model, a Graph Neural Network (GNN) model, or the like, or a combination thereof.

In some embodiments, an input of the flow regulation model 320 may be the target gas mixing feature 310 and the plurality of candidate flow regulation parameters 312, and an output of the flow regulation model 320 may be the predicted effective values 330 corresponding to the plurality of candidate flow regulation parameters.

Candidate flow regulation parameters refer to a set of parameters to be determined as the second flow regulation parameter. More descriptions regarding the target gas mixing feature and the second flow regulation parameter may be found in FIG. 2 and related descriptions thereof.

In some embodiments, the gas company management platform may determine the candidate flow regulation parameters in a variety of ways. For example, the gas company management platform may identify a plurality of historical flow regulation parameters that have a similarity greater than a similarity threshold as the candidate flow regulation parameters. The similarity threshold may be set by default by the gas company management platform or predetermined by a technician based on experience. More descriptions regarding the historical flow regulation parameters may be found in FIG. 2 and related descriptions thereof.

The predicted effective value of a candidate flow regulation parameter refers to a parameter used to reflect a degree to which the candidate flow regulation parameter meets the demands of a downstream gas user.

In some embodiments, the flow regulation model is obtained by training based on flow regulation training samples and flow regulation labels. The flow regulation training samples include sample gas mixing features and sample flow regulation parameters. The flow regulation labels include sample effective values.

In some embodiments, the flow regulation model may be obtained by various feasible training manners based on a plurality of flow regulation training samples with flow regulation labels. For example, parameters may be updated based on a gradient descent technique. An exemplary training process includes: obtaining a plurality of flow regulation training samples with flow regulation labels, inputting the plurality of flow regulation training samples with the flow regulation labels into an initial flow regulation model, constructing a loss function based on the flow regulation labels and results of the initial flow regulation model, and iteratively updating parameters of the initial flow regulation model by gradient descent or other techniques based on the loss function. The training process is completed when a preset termination condition is met, and the trained flow regulation model is obtained. The preset termination condition may be that the loss function converges, a count of iterations reaches a threshold, etc.

In some embodiments, the flow regulation training sample may be determined based on historical data. For example, the gas company management platform may determine two and more sets of flow regulation training samples based on historical gas mixing features and historical flow regulation parameters and train the initial flow regulation model alternately using the two and more sets of flow regulation training samples. One set of flow regulation training samples corresponds to scenarios where no valid gas feature of a matching gas source exists; another set of flow regulation training samples corresponds to scenarios where the timeliness attribute of the gas feature of at least one matching gas source is invalid.

In some embodiments, the flow regulation label of a flow regulation training sample may be a sample effective value corresponding to the flow regulation training sample. The flow regulation label may be determined based on the historical data. For example, the flow regulation label may be an average of actual effective values obtained after a plurality of flow regulations conducted at different times, generated based on the gas user feedback information corresponding to the sample flow regulation parameter. More descriptions regarding the gas user feedback information may be found in FIG. 2 and related descriptions thereof. More descriptions regarding the actual effective value may be found in FIG. 2 and related descriptions thereof.

By training the flow regulation model using the flow adjustment training samples and their corresponding flow adjustment labels, a more accurate predictive model can be obtained. This enables the flow regulation model to more precisely predict the estimated effective value, optimize the second flow regulation parameters, enhance system efficiency and accuracy, and meet complex and varying gas mixing demands.

In some embodiments, the input of the flow regulation model may further include deposit data. More descriptions regarding the deposit data may be found in FIG. 4 and related descriptions thereof.

In some embodiments, when the input of the flow regulation model further includes the deposit data, the flow regulation training sample further includes sample deposit data.

Considering that pipeline deposits also affect gas mixing features (e.g., a calorific value, a temperature, and a combustion rate), the reliability of the output of the flow regulation model can be further improved by incorporating the deposit data as the input of the flow regulation model.

In some embodiments, the gas company management platform may determine the second flow regulation parameter based on the predicted effective value in various ways. For example, the gas company management platform may determine the candidate flow regulation parameter corresponding to the highest predicted effective value as the second flow regulation parameter.

The trained flow regulation model can quickly and accurately generate the predicted effective values of different candidate flow regulation parameters. Subsequently, based on the magnitudes of the predicted effective values, the optimal flow regulation parameter can be quickly and accurately selected from the candidate flow regulation parameters as the second flow regulation parameter.

FIG. 4 is a flowchart of an exemplary process for determining an updated gas feature according to some embodiments of the present disclosure. In some embodiments, process 400 may be performed by a gas company management platform (e.g., the gas company management platform 131).

In 410, obtaining gas user feedback information of a gas user corresponding to a downstream gas pipeline via a gas user service platform (e.g., the gas user service platform 160) and through a gas user platform (e.g., the gas user platform 170).

The downstream gas pipeline refers to a gas pipeline which is located downstream of a current gas pipeline. The gas user corresponding to the downstream gas pipeline refers to one or more gas users supplied by the downstream gas pipeline.

The gas user feedback information refers to negative feedback provided by the gas user after using gas supply. In some embodiments, the gas user feedback information may include a severity coefficient, a feedback time interval, etc. More descriptions regarding the severity coefficient and the feedback time interval may be found in FIG. 2.

In some embodiments, the gas user inputs the gas user feedback information via the gas user platform.

In 420, sending a collection instruction via a gas company sensing network platform (e.g., the gas company sensing network platform 140) and through a gas device object platform (e.g., the gas device object platform 150) to collect deposit data based on a pipeline monitoring device, and/or retrieving the deposit data from a gas data center.

More descriptions regarding the pipeline monitoring device and the gas data center may be found in the relevant descriptions of FIG. 1.

The collection instruction refers to an instruction used to collect the deposit data. The deposit data refers to data related to deposits in a gas pipeline to be regulated. The deposits may be impurities adhering to an inner wall of the gas pipeline. The impurities may mix into the gas and affect its quality.

In some embodiments, the deposit data may include at least one of a deposit type, a deposit thickness, etc.

In some embodiments, the pipeline monitoring device may be configured to collect the deposit data.

In some embodiments, the gas company management platform may be configured to collect the deposit data via the pipeline monitoring device. In some embodiments, the gas company management platform may also retrieve the deposit data directly from the gas data center.

In 430, re-determining an updated gas feature based on the gas user feedback information and the deposit data.

The updated gas feature refers to a gas feature after update.

In some embodiments, the gas company management platform may update the gas feature stored in the gas data center to the updated gas feature.

In some embodiments, the gas company management platform may determine the updated gas feature of a matching gas source in various ways. For example, the gas company management platform obtains the gas user feedback information from a gas user corresponding to the gas pipeline and the deposit data of the gas pipeline to be regulated after gas flow regulation. Based on the gas user feedback information and the deposit data, updated gas features of matching gas sources of different gas pipelines to be regulated are determined.

In some embodiments, the gas company management platform may determine the updated gas features of the matching gas sources of different gas pipelines to be regulated in various ways. The updated gas feature is inversely proportional to an influence coefficient of the deposits (also referred to as a deposit influence coefficient) and inversely proportional to an amount of gas user feedback information. For example, the gas company management platform may determine the updated gas features of the matching gas sources of different gas pipelines to be regulated through Equation (2):

$$F = A \times ( 1 - {b}_{i} / d ) \times ( 1 - k ) . \qquad ( 2 )$$

In Equation (2), F denotes the updated gas feature, A denotes the gas feature, and k denotes the deposit influence coefficient. More descriptions regarding the definitions of b; and the d may be found in related descriptions of Equation (1) in FIG. 2.

In some embodiments, the gas feature may be obtained based on historically monitored gas feature, and/or retrieved directly from the gas data center.

In some embodiments, the gas company management platform may determine the influence coefficient of the deposits based on the deposit data by querying a deposit influence table. The deposit influence table includes deposit data, deposit influence coefficients of different gas pipelines to be regulated, and a correspondence relationship between the deposit data and the deposit influence coefficients. The deposit influence table may be constructed based on historical pipeline operation data. For example, the gas company management platform gathers historical pipeline operation data where gas features are identical or similar, along with corresponding historically monitored deposit data (also identical or similar) and their respective actual effective values. Multiple instances of identical or similar historical deposit data are grouped as a single historical deposit data. An average of (1-actual effective value) from the multiple corresponding historical pipeline operation data is then calculated and designated as the deposit influence coefficient for the historical deposit data, thereby building the deposit influence table. The historical pipeline operation data refers to all data recorded during the past operation of a pipeline, including historical flow regulation data, etc. The gas company management platform may directly acquire the historical pipeline operation data from the gas data center. The gas company management platform may construct vectors based on the historical deposit data, determine a cosine similarity for each of the vectors, and identify historical deposit data as similar if their corresponding vectors have a cosine similarity greater than 0.8.

In some embodiments, the gas company management platform may re-determine the updated gas feature based on the gas user feedback information and the deposit data through a predetermined algorithm.

The predetermined algorithm refers to an algorithm predetermined for determining the updated gas feature. The predetermined algorithm may include a statistical inference algorithm, etc.

In some embodiments, the gas company management platform may obtain the gas feature of the gas pipeline to be regulated from the gas data center, and determine a difference between the updated gas feature and the gas feature based on the gas user feedback information, etc. For example, a magnitude of the difference between the updated gas feature and the gas feature is positively proportional to the amount of gas user feedback information. The updated gas feature is determined using the predetermined algorithm. The gas feature refers to one or more gas features collected at a previous time point of the current time point. The updated gas feature is inversely proportional to an inference coefficient, the amount of gas user feedback information, and the deposit influence coefficient, and positively proportional to the feedback time interval.

For example, the predetermined algorithm may be represented by Equation (3):

$${F}_{s} = {F}_{l} \times ( 1 - {\sum }_{i = 1}^{N} \frac{{ε}_{i} \times {b}_{i} \times {e}^{1 - {c}_{i}}}{d} ) ( 1 - k ) . \qquad ( 3 )$$

In Equation (3), Fₛ denotes the updated gas feature (e.g., a calorific value, a combustion rate, a gas pressure), Fₗ denotes the gas feature, εᵢ denotes the inference coefficient corresponding to the ith time interval. More descriptions regarding the definitions of N, i, bᵢ, cᵢ, d, and k may be found in the relevant descriptions of Equation (1) in FIG. 2 and Equation (2) in FIG. 4.

The inference coefficient refers to a coefficient related to the gas user feedback information. The inference coefficient may reflect a size of a group of gas users corresponding to the gas user feedback information.

In some embodiments, the gas company management platform may determine the inference coefficient in various ways. For example, the gas company management platform may obtain geographic coordinates and geographic distances of the gas users who submitted the gas user feedback information at a same time point. Based on the geographic coordinates and the geographic distances of the gas users, the gas company management platform may generate a flow regulation influencing range, and generate the inference coefficient based on a count of gas users within the flow regulation influencing range.

The flow regulation influencing range may be a circular area, a center of which is a gas pipeline, and a diameter of which is a geographic distance between the geographic coordinates of the two farthest apart gas users in a gas transmission region corresponding to the gas pipeline.

The inference coefficient characterizes a likelihood of the gas users within the flow regulation influencing range being negatively affected by the flow regulation. In some embodiments, the inference coefficient may be expressed as a ratio between the count of gas users within the flow regulation influencing range and the count of gas users who submitted the gas user feedback information.

By re-determining the updated gas feature through the predetermined algorithm based on the gas user feedback information and the deposit data, considerations are made for the fact that the gas user feedback information may not always exist and may not be representative of the majority of gas users. This approach allows for determining an inference coefficient that represents the majority of gas users, thereby enabling the identification of the gas feature that better aligns with reality.

In 440, updating the gas feature stored in the gas data center to the updated gas feature based on a predetermined update cycle.

The predetermined update cycle refers to a pre-defined time interval for updating the gas feature.

In some embodiments, the gas company management platform may determine the predetermined update cycle by querying a cycle table. In some embodiments, the cycle table may include timeliness attributes of gas features of different matching gas sources, amounts of different gas user feedback information, deposit thicknesses in different deposit data, and predetermined update cycles (e.g., 1 day and 7 days) corresponding to the gas features, and a relationship thereof. In some embodiments, the cycle table may be constructed based on historical data. For example, the gas company management platform may analyze historical data in which, for each combination of a timeliness attribute of a gas feature of a matching gas source, an amount of gas user feedback information, a deposit thickness in deposit data, a subsequent significant decrease (e.g., an 80% reduction) in the gas user feedback information occurred after updating according to an adjusted historical update cycle. The adjusted historical update cycle is then established as the predetermined update cycle corresponding to the combination in the cycle table.

Re-determining the updated gas feature and periodically updating the updated gas feature based on the gas user feedback information and the deposit data can facilitate full consideration of the difference between the known or historically stored gas feature and the actual gas feature. This approach allows for the redetermination of the updated gas feature which is more in line with reality, and thus provides effective data support for determining reasonable gas flow regulation parameters.

It should be noted that the foregoing descriptions of the process 200 and the process 400 are intended to be exemplary and illustrative only and do not limit the scope of the present disclosure. For a person skilled in the art, various corrections and changes may be made to the process 200 and the process 400 under the guidance of the present disclosure. However, these corrections and changes remain within the scope of the present disclosure.

One or more embodiments of the present disclosure provide a non-transitory computer-readable storage medium storing computer instructions. When reading the computer instructions in the storage medium, a computer implements the method for smart regulation and control of a gas flow described in one or more embodiments of the present disclosure.

The basic concepts have been described above, and it is apparent to those skilled in the art that the foregoing detailed disclosure serves only as an example and does not constitute a limitation of the present disclosure. While not expressly stated herein, various modifications, improvements, and amendments may be made to the present disclosure by those skilled in the art. Those types of modifications, improvements, and amendments are suggested in the present disclosure, so those types of modifications, improvements, and amendments remain within the spirit and scope of the exemplary embodiments of the present disclosure.

In addition, the order of processing elements and sequences, the use of numerical letters, or the use of other names described in the present disclosure are not intended to qualify the order of the processes and methods of the present disclosure, unless expressly stated in the claims. While some embodiments of the present disclosure that are currently considered useful are discussed in the foregoing disclosure by way of various examples, it is to be understood that such details serve only illustrative purposes, and that additional claims are not limited to the disclosed embodiments, rather, the claims are intended to cover all amendments and equivalent combinations that are consistent with the substance and scope of the embodiments of the present disclosure. For example, although the implementation of various components described above may be embodied in a hardware device, it may also be implemented as a software only solution, e.g., an installation on an existing server or mobile device.

Similarly, it should be noted that in order to simplify the presentation of the disclosure of the present disclosure, and thereby aid in the understanding of one or more embodiments of the present disclosure, the foregoing descriptions of the embodiments of the present disclosure sometimes combine a variety of features into a single embodiment, drawings, or a description thereof. However, this way of disclosure does not imply that the objects of the present disclosure require more features than those mentioned in the claims. Rather, claimed subject matter may lie in less than all features of a single foregoing disclosed embodiment.

Numbers describing the number of compositions, attributes are used in some embodiments, and it should be understood that such numbers used in the description of embodiments, in some examples, use the modifiers “about”, “approximately”, or “generally” is used in some examples. Unless otherwise noted, the terms “about,” “approximate,” or “approximately” indicates that a variation of ±20% is allowed in the stated figure, unless otherwise stated. Correspondingly, in some embodiments, the numerical parameters used in the specification and claims are approximations, which may change depending on the desired characteristics of individual embodiments. In some embodiments, the numerical parameters should take into account the specified number of valid digits and use a general digit retention method. While the numerical domains and parameters used to confirm the breadth of the ranges in some embodiments of the present disclosure are approximations, in specific embodiments such values are set to be as precise as possible within a feasible range.

Finally, it should be understood that the embodiments described herein are used only to illustrate the principles of embodiments of the present disclosure. Other deformations may also fall within the scope of the present disclosure. As such, alternative configurations of embodiments of the present disclosure may be viewed as consistent with the teachings of the present disclosure as an example, not as a limitation. Correspondingly, the embodiments of the present disclosure are not limited to the embodiments expressly presented and described herein.

What is claimed is:

1. An Internet of Things (IoT) system for smart regulation and control of a gas flow, comprising a governmental gas supervision management platform, a governmental gas supervision sensing network platform, a governmental gas supervision object platform, a gas company sensing network platform, and a gas device object platform, which are communicatively connected; wherein
the governmental gas supervision object platform includes a gas company management platform; the gas company management platform is communicatively connected to a gas user platform through a gas user service platform; the gas company management platform is configured on a server of a gas company, and the server is provided with a gas data center; the gas device object platform is communicatively connected to a flow regulation device;
the gas company management platform is configured to:
determine whether a gas feature of a matching gas source corresponding to a gas pipeline to be regulated exists in the gas data center;
in response to determining that the gas feature exists in the gas data center, retrieve the gas feature from the gas data center, and generate a timeliness attribute of the gas feature;
generate a first flow regulation parameter based on the gas feature and the timeliness attribute; and
based on the first flow regulation parameter, send a flow regulation instruction to the flow regulation device provided on the gas pipeline to be regulated via the gas company sensing network platform and through the gas device object platform, to adjust a gas flow rate and a gas pressure allocated to the gas pipeline to be regulated, wherein a gas in the gas pipeline to be regulated is mixed in a gas pipeline to generate a mixed gas.

2. The system of claim 1, wherein the gas company management platform is further configured to:
in response to determining that the gas feature does not exist in the gas data center and/or the timeliness attribute includes invalidity, generate a second flow regulation parameter for a future time point based on a historical gas mixing feature of the mixed gas and a historical flow regulation parameter;
based on the second flow regulation parameter, send the flow regulation instruction to the flow regulation device via the gas company sensing network platform and through the gas device object platform, to pre-adjust the gas flow rate and the gas pressure allocated to the gas pipeline to be regulated; and
send the second flow regulation parameter to the governmental gas supervision management platform via the governmental gas supervision sensing network platform.

3. The system of claim 2, wherein the gas company management platform is further configured to:
determine, based on a target gas mixing feature and a plurality of candidate flow regulation parameters, predicted effective values of the plurality of candidate flow regulation parameters through a flow regulation model, the flow regulation model being a machine learning model; and
determine the second flow regulation parameter based on the predicted effective values.

4. The system of claim 3, wherein the flow regulation model is obtained by training based on flow regulation training samples and flow regulation labels, the flow regulation training samples including sample gas mixing features and sample flow regulation parameters, and the flow regulation labels including sample effective values.

5. The system of claim 3, wherein an input of the flow regulation model further includes deposit data.

6. The system of claim 2, wherein the gas feature includes a valid gas feature, and the gas company management platform is further configured to:
generate the second flow regulation parameter based on the historical gas mixing feature, the historical flow regulation parameter, and the valid gas feature.

7. The system of claim 6, wherein the gas company management platform is further configured to:
determine, through the gas data center, a third flow regulation parameter satisfying a predetermined condition based on the valid gas feature and a gas source type and gas source physical state of an invalid matching gas source; and
generate the second flow regulation parameter based on the third flow regulation parameter.

8. The system of claim 6, wherein the predetermined condition includes an actual effective value of the third flow regulation parameter being greater than a predetermined threshold, and the actual effective value is determined based on gas user feedback information of a gas user.

9. The system of claim 1, wherein the gas company management platform is further configured to:
obtain gas user feedback information of a gas user corresponding to a downstream gas pipeline via the gas user service platform and through the gas user platform;
send a collection instruction via the gas company sensing network platform and through the gas device object platform to collect deposit data based on a pipeline monitoring device, and/or retrieve the deposit data from the gas data center, the gas device object platform being communicatively connected to the pipeline monitoring device;
re-determine an updated gas feature based on the gas user feedback information and the deposit data; and
update the gas feature stored in the gas data center to the updated gas feature based on a predetermined update cycle.

10. The system of claim 9, wherein the gas company management platform is further configured to:
re-determine the updated gas feature based on the gas user feedback information and the deposit data through a predetermined algorithm.

11. A method for smart regulation and control of a gas flow, the method being executed by a gas company management platform of an Internet of Things (IoT) system for smart regulation and control of a gas flow, the gas company management platform being configured on a server of a gas company, the server being provided with a gas data center; the method comprising:
determining whether a gas feature of a matching gas source corresponding to a gas pipeline to be regulated exists in the gas data center;
in response to determining that the gas feature exists in the gas data center, retrieving the gas feature from the gas data center, and generating a timeliness attribute of the gas feature;
generating a first flow regulation parameter based on the gas feature and the timeliness attribute; and
based on the first flow regulation parameter, sending a flow regulation instruction to the flow regulation device provided on the gas pipeline to be regulated via a gas company sensing network platform and through a gas device object platform, to adjust a gas flow rate and a gas pressure allocated to the gas pipeline to be regulated, wherein a gas in the gas pipeline to be regulated is mixed in a gas pipeline to generate a mixed gas.

12. The method of claim 11, further comprising:
in response to determining that the gas feature does not exist in the gas data center and/or the timeliness attribute includes invalidity, generating a second flow regulation parameter for a future time point based on a historical gas mixing feature of the mixed gas and a historical flow regulation parameter;
based on the second flow regulation parameter, sending the flow regulation instruction to the flow regulation device via the gas company sensing network platform and through the gas device object platform, to pre-adjust the gas flow rate and the gas pressure allocated to the gas pipeline to be regulated; and
sending the second flow regulation parameter to a governmental gas supervision management platform via a governmental gas supervision sensing network platform.

13. The method of claim 12, further comprising:
determining, based on a target gas mixing feature and a plurality of candidate flow regulation parameters, predicted effective values of the plurality of candidate flow regulation parameters through a flow regulation model, the flow regulation model being a machine learning model; and
determining the second flow regulation parameter based on the predicted effective values.

14. The method of claim 13, wherein an input of the flow regulation model further includes deposit data.

15. The method of claim 12, wherein the gas feature includes a valid gas feature, and the method further comprises:
generating the second flow regulation parameter based on the historical gas mixing feature, the historical flow regulation parameter, and the valid gas feature.

16. The method of claim 15, further comprising:
determining, through the gas data center, a third flow regulation parameter satisfying a predetermined condition based on the valid gas feature and a gas source type and gas source physical state of an invalid matching gas source; and
generating the second flow regulation parameter based on the third flow regulation parameter.

17. The method of claim 15, wherein the predetermined condition includes an actual effective value of the third flow regulation parameter being greater than a predetermined threshold, and the actual effective value is determined based on gas user feedback information of a gas user.

18. The method of claim 11, further comprising:
obtaining gas user feedback information of a gas user corresponding to a downstream gas pipeline via a gas user service platform and through a gas user platform;
sending a collection instruction via the gas company sensing network platform and through the gas device object platform to collect deposit data based on a pipeline monitoring device, and/or retrieving the deposit data from the gas data center, the gas device object platform being communicatively connected to the pipeline monitoring device;
re-determining an updated gas feature based on the gas user feedback information and the deposit data; and
updating the gas feature stored in the gas data center to the updated gas feature based on a predetermined update cycle.

19. The method of claim 18, wherein the re-determine an updated gas feature based on the gas user feedback information and the deposit data includes:
re-determining the updated gas feature based on the gas user feedback information and the deposit data through a predetermined algorithm.

20. A non-transitory computer-readable storage medium storing computer instructions, wherein when reading the computer instructions in the storage medium, a computer implements a method for smart regulation and control of a gas flow, the method being executed by a gas company management platform of an Internet of Things (IoT) system for smart regulation and control of a gas flow, the gas company management platform being configured on a server of a gas company, the server being provided with a gas data center; the method comprising:
determining whether a gas feature of a matching gas source corresponding to a gas pipeline to be regulated exists in the gas data center;
in response to determining that the gas feature exists in the gas data center, retrieving the gas feature from the gas data center, and generating a timeliness attribute of the gas feature;
generating a first flow regulation parameter based on the gas feature and the timeliness attribute; and
based on the first flow regulation parameter, sending a flow regulation instruction to the flow regulation device provided on the gas pipeline to be regulated via a gas company sensing network platform and through a gas device object platform, to adjust a gas flow rate and a gas pressure allocated to the gas pipeline to be regulated, wherein a gas in the gas pipeline to be regulated is mixed in a gas pipeline to generate a mixed gas.
